(19) United States
(12) Patent Application Publication
(10) Pub. No.: US 2009/0083382 A1
(43) Pub. Date: Mar. 26, 2009

(54) REAL-TIME PRESENCE OF ONLINE CONTACTS

(75) Inventors: Greg A. Rosenberg, San Mateo, CA (US); Samir B. Mehta, San Francisco, CA (US); Ethan H. Diamond, San Francisco, CA (US)

Correspondence Address: MORRISON & FOERSTER LLP, 425 MARKET STREET, SAN FRANCISCO, CA, 94105-2482, US

(73) Assignee: YAHOO! INC., Sunnyvale, CA (US)

(21) Appl. No.: 11/860,523

(22) Filed: Sep. 24, 2007

(51) Int. Cl. G06F 15/16

(52) U.S. Cl. 709/206

(57) ABSTRACT

In accordance with embodiments of the present invention, a method for dynamically generating online contacts for an instant messaging (IM) environment in response to receiving login information from a user is provided. The method includes receiving at least one predetermined core IM contact associated with the user at a core IM server, and receiving a query for a presence status of at least one predetermined e-mail contact associated with the user from an e-mail application. A presence status is determined for the at least one predetermined core IM contact and the at least one predetermined e-mail contact. After returning the determined presence status of the at least one predetermined core IM contact for consolidating with the determined presence status of the at least one e-mail contact. An online presence contact list is generated using the determined presence status of the at least one IM contact and the at least one e-mail contact.

### BACKGROUND OF THE INVENTION

Instant messaging, or IM, is a text-based tool that allows users to easily send messages to other parties in real-time when connected to the Internet. Often, communication via instant messaging (IM) is only possible within a closed community of registered users. Users are required to sign in to the system with a pre-selected user name and password before sending instant messages is possible.

Previously, a registered user defines a list of IM contacts, which is provided to them when they sign in to the IM system. However, there are several drawbacks of having a user define their own IM contact list. For example, a major drawback of current IM contact lists is that a user is only able to add an IM contact to their list if the other user is a member of the same instant messaging system. In other words, users of different types of instant messaging networks are generally not able to communicate with each other using instant messaging because each of the IM networks uses its own proprietary protocol.

Furthermore, registering for IM may also register a user for an e-mail account, or other services, and vice versa. Many users that may have registered for an e-mail account may not have used an instant messaging system before. Consequently, those users may have many contacts in their e-mail address book who they frequently communicate with via e-mail, but have no “buddies” or “friends” on their IM contact lists. In order to add an e-mail contact, the user will have to be aware of an identifying factor of another user to be able to add them to their own IM contact list.

Therefore, generation of an online contact list for instant messaging by integrating contact lists from the user's other IM or e-mail accounts is desired.

### BRIEF SUMMARY OF THE INVENTION

In accordance with embodiments of the present invention, a method for dynamically generating online contacts for an instant messaging (IM) environment in response to receiving login information from a user is provided. The method includes receiving at least one predetermined core IM contact associated with the user at a core IM server, and receiving a query for a presence status of at least one predetermined e-mail contact associated with the user from an e-mail application. A presence status is determined for the at least one predetermined core IM contact and the at least one predetermined e-mail contact. After returning the determined presence status of the at least one predetermined core IM contact for consolidating with the determined presence status of the at least one e-mail contact. An online presence contact list is generated using the determined presence status of the at least one IM contact and the at least one e-mail contact. In some embodiments, the presence status of at least one non-core IM contact is determined and included in the generation of the online presence contact list.

In accordance with other embodiments of the present invention, an apparatus for dynamically generating online contacts for an instant messaging (IM) environment in response to receiving login information from a user is provided. The apparatus includes logic for receiving at least one predetermined IM contact associated with the user from a user database, and logic for determining a presence status for the at least one predetermined core IM contact and the at least one predetermined e-mail contact. The at least one predetermined e-mail contact is associated with a user and received from an e-mail application. The apparatus further includes logic for sending the determined presence status of the at least one predetermined core IM contact for consolidating with the determined presence status of the at least one e-mail contact, from which an online presence contact list is generated.

Furthermore, in accordance with other embodiments of the present invention, a computer-readable medium program code for performing a method for dynamically generating online contacts for an instant messaging (IM) environment in response to receiving login information from a user. The program code is for receiving at least one predetermined core IM contact associated with the user at a core IM server, and receiving a query for a presence status of at least one predetermined e-mail contact associated with the user from an e-mail application. The program code is further for determining a presence status for the at least one predetermined core IM contact and the at least one predetermined e-mail contact. After returning the determined presence status of the at least one predetermined core IM contact, the program code includes instructions for consolidating with the determined presence status of the at least one e-mail contact. An online presence contact list is generated using the determined presence status of the at least one IM contact and the at least one e-mail contact.

Other features and aspects of the invention will become apparent from the following detailed description, taken in conjunction with the accompanying drawings which illustrate, by way of example, the features in accordance with embodiments of the invention. The summary is not intended to limit the scope of the invention.

### BRIEF DESCRIPTION OF THE DRAWINGS

FIG. 1 illustrates a flowchart of a method of generating presence status from IM contacts of a user by an IM server according to embodiments of the invention;

FIG. 2 illustrates a flowchart of a method of generating presence status of e-mail contacts of a user by a presence platform according to embodiments of the invention;

FIG. 3 illustrates generating an integrated online presence contact list for a user according to embodiments of the invention;

FIG. 4 illustrates a block diagram of a presence system according to embodiments of the invention;

FIG. 5 illustrates an exemplary integrated online presence contact list according to embodiments of the invention; and

FIG. 6 illustrates a block diagram of a computing system according to embodiments of the invention.

In the following description, reference is made to the accompanying drawings which form a part thereof, and which illustrate several embodiments of the present invention. It is understood that other embodiments may be utilized and structural and operational changes may be made without departing from the scope of the present invention. The use of the same reference symbols in different drawings indicates similar or identical items.

### DETAILED DESCRIPTION OF THE INVENTION

The following description is presented to enable any person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown.

New IM users may not have a pre-existing IM contact list, or IM friend/buddy list. On the other hand, those users may have many e-mail contacts in their e-mail address books. A unified list of online contacts (i.e. IM-able contacts) from at least two sources may be a solution of users who did not possess an IM contact list previously.

A first source may be from a pre-defined IM contact list. The traditional IM contact list comprises “friends” or “buddies,” which is created via a “friend request” or “add buddies” mechanism. With the “friend request” mechanism, the user may request permission from a user for adding the user to their IM contact list, or add a desired IM contact if an identifying characteristic is known that is sufficient for the user to add the user to their IM contact list. This is currently found in the IM system client application.

A second source for generating an online contact list may be from the user's e-mail address book. An e-mail address book includes e-mail addressees of contacts that the user has stored. To generate an integrated online contact list, the contacts of the e-mail address book may be parsed the contents to evaluate for eligible IDs and/or email addresses that are IM-able contacts. The eligible addresses are then passed to a presence platform, which return the online presence (the ability to receive instant messages) for each of those contacts, and combined into a list with any additional sources of online contacts.

The system may provide new IM users a list of online contacts without having to define a separate list from an existing e-mail contact list. This will allow a user to easily use IM as a new communications medium. Furthermore, another advantage is that existing IM users may expand their list of IM-able online contacts by including other sources of contacts they might have that are not already on their exiting IM contact lists.

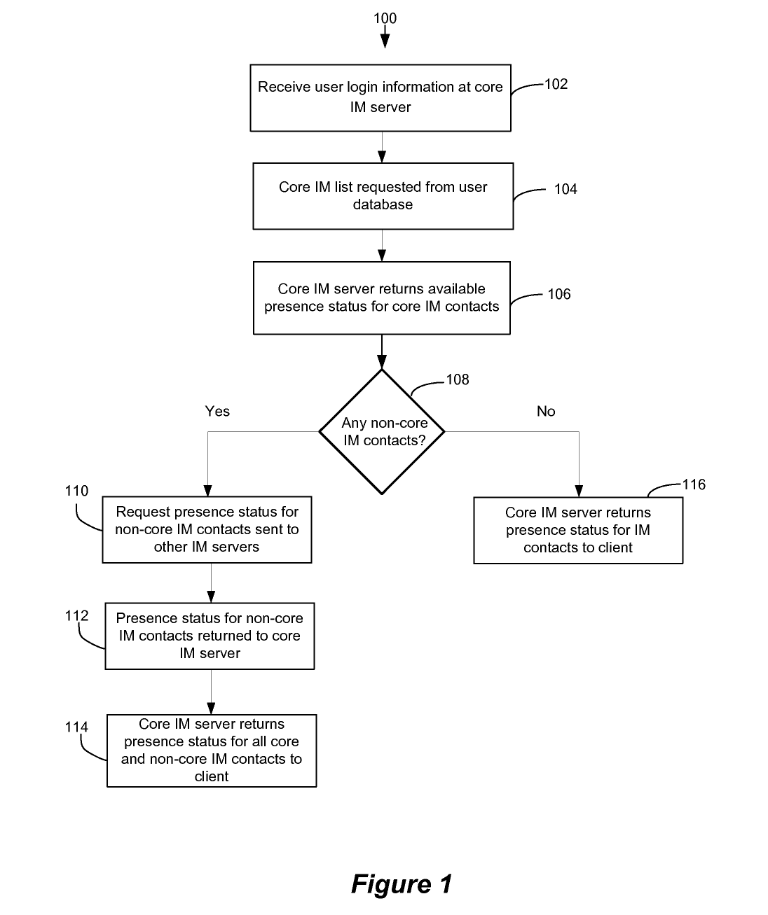

FIG. 1 illustrates a flowchart of a method of generating presence status from IM contacts of a user by an IM server according to embodiments of the invention. The exemplary method 100 initiates with a user logging into the system via a login request at a core IM server 102. The user logging into the system may be a user logging into their e-mail account and simultaneously logs into a messenger in mail application. The user may log in to the system using a user ID and password, for example. The user's login information is received at core IM server, where the user's login information is authenticated. In response to authenticating the user's login information, the core IM server returns a list of the core IM contacts 104, such as a “buddy list.” The core IM server determines the presence status of the core IM contacts included on the user's buddy list 106, i.e., if the core IM contacts are online, offline, idle, or busy.

A decision is made if the user has IM contacts that are not from the core IM system 108. For example, if a user has a Yahoo! user account, the user may login to a Yahoo! user account. In this case, the core IM server is the Yahoo! IM server. However, the user may have more than just a Yahoo! account. The user may have a MSN or AIM IM account as well. Therefore, the user may have non-core IM contacts. The user may predefine other IM contacts or the IM server may query other IM servers for an IM account associated with the user.

If it is determined the user only has core IM contacts, the presence status of the core IM contacts is returned to the client.

On the other hand, in some embodiments, if it is determined the user has non-core IM contacts, the core IM server requests presence status for the non-core IM contacts from each respective non-core IM server 110. The presence status is returned to the core server 112. Then, the core server returns the presence status of the user's core and non-core IM contacts to the client 114.

As the user logs into their e-mail account, they may be simultaneously logging into a messenger in mail application. As described above, the initial logging into the system initiates the process to determine at least one IM contact. According to embodiments of the invention, the presence of the user's e-mail contacts is determined as a partial input to generate the integrated online presence contact list.

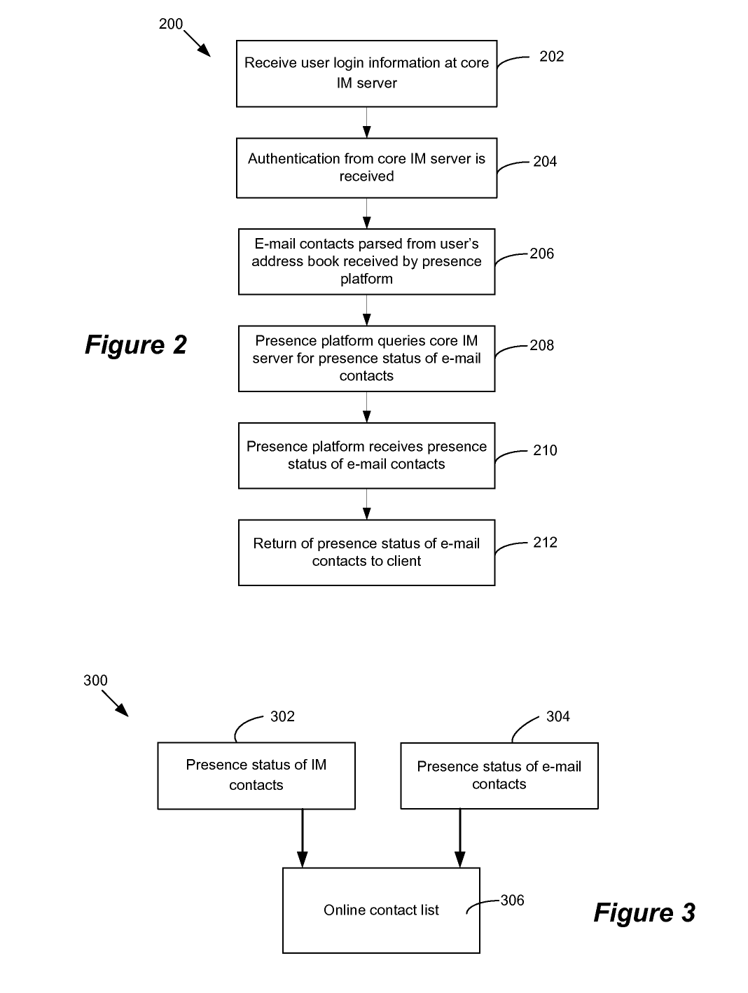

Accordingly, FIG. 2 illustrates a flowchart of a method of generating presence status of e-mail contacts of a user by a presence platform according to embodiments of the invention. As described above, the user login information is received at the core IM serer 202. The core IM server authenticates the user login information and confirmation of successful authentication is received at the client 204. The e-mail contacts are then parsed from the user's e-mail address book. The e-mail contacts are received by a presence platform 206. After receiving the e-mail contacts that are to be queried to an IM server, a subscription for the e-mail contacts is created and a query is issued to the core IM server to determine the presence status of the e-mail contacts 208. The e-mail contacts may have set privacy setting to not allow other users to determine presence status of their contact information. The presence status of the e-mail contacts is returned to the presence platform 210, and subsequently returned to the client 312. The presence status of the e-mail contacts is used as an input to generate the online presence contact list.

As illustrated in FIG. 3, according to embodiments of the invention, the client consolidates the presence status of both IM and e-mail contacts into a unified online presence contact list in method 300. After the client receives at least the presences status of the e-mail contacts from the presence platform 304 and the presence status of the IM contacts from the core IM server 402, an online contact list is generated 406. The online contact list is dynamically generated and includes all the user's accessible contacts that the user may IM.

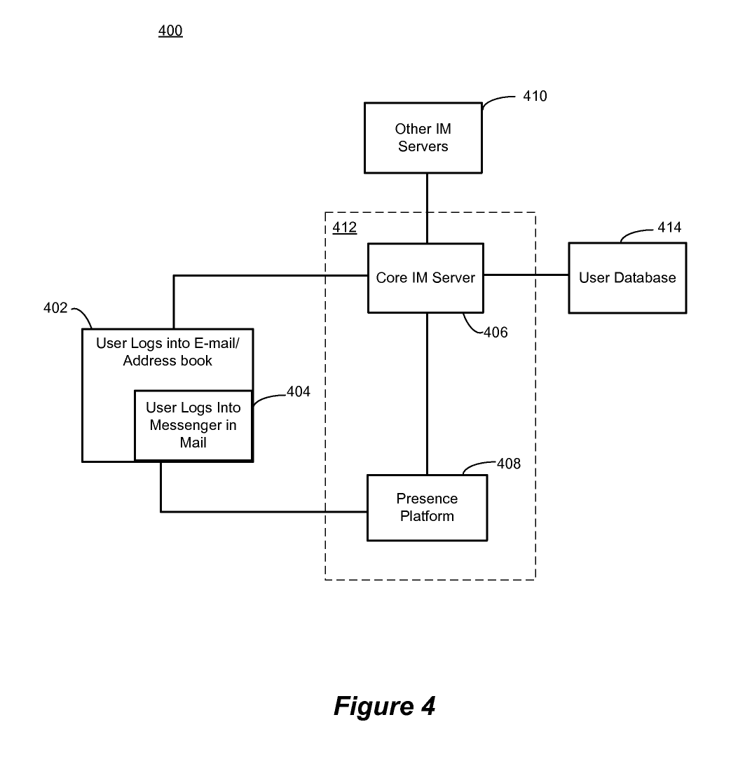

FIG. 4 illustrates a block diagram of a presence system according to embodiments of the invention for performing the methods and functions described above for generating an online presence contact list. At the client, a user logs into their e-mail account, allowing accessibility to an e-mail address book 402. Consequently, by the user logging into their e-mail account, the user may be logging into a messenger in mail application 404. The client is connected to both a core IM server 406 and a presence platform 408. Server requests to both the core IM server 406 and the presence platform 408 request presence status, respectively, of the IM contacts and the e-mail contacts. The core IM server 406 is able to communicate with other IM servers 410 to request presence status of non-core IM contacts. The IM server 406 is also connected to a user database 414 to receive a buddy list belonging to the user. The presence platform 408 is able to communicate with the core IM server 406 in order to query IM servers with the user's e-mail contacts to determine presence status. The client receives presence status from presence system 412, including the core IM server 406 and the presence platform 408.

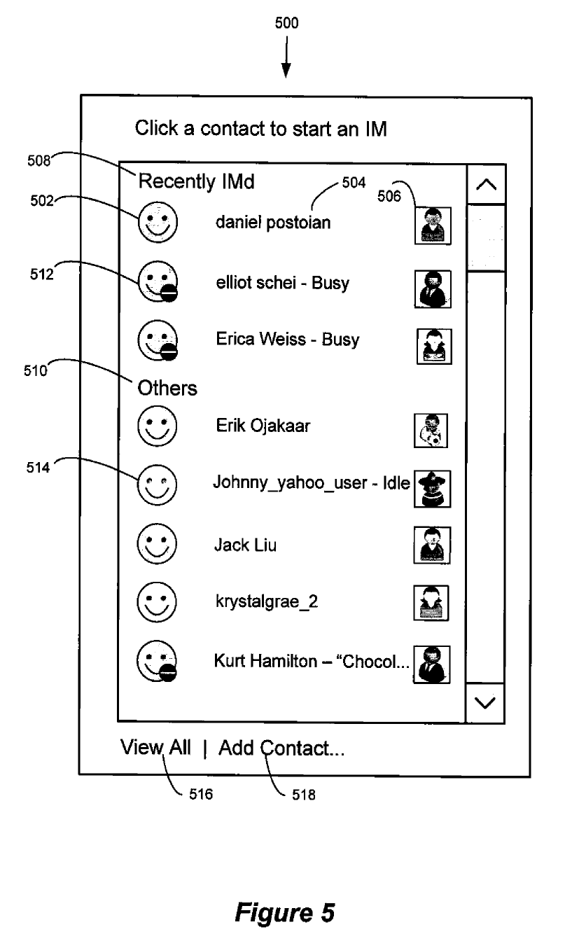

An example of an online presence contact list according to embodiments of the invention is illustrated in FIG. 5. An online contact list 500 generated at the client 402 shows user contacts that may be IMed by the user. For each online contact, the type of online status may be shown by the online contact's name. For example, user online contact “daniel postoian” 504 is provided on the user's online contact list 500. The type of online status is illustrated by an “active” online status symbol 502. Other online status symbols may be provided on the online contact list 500 such as a “busy” online status 512 or an “idle” online status 514. Further, an online contact may have an associated customized icon 506 to be provided on other user's online contact lists. The online contact list 500 may be organized into “Recently IMd” online contacts 508 and “Other” online contacts 510. Other functions such as “View All” 516, or “Add Contact” 518 may be also provided on the online contact list 500.

While aspects of the invention, including the above described systems and methods, are described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic, and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

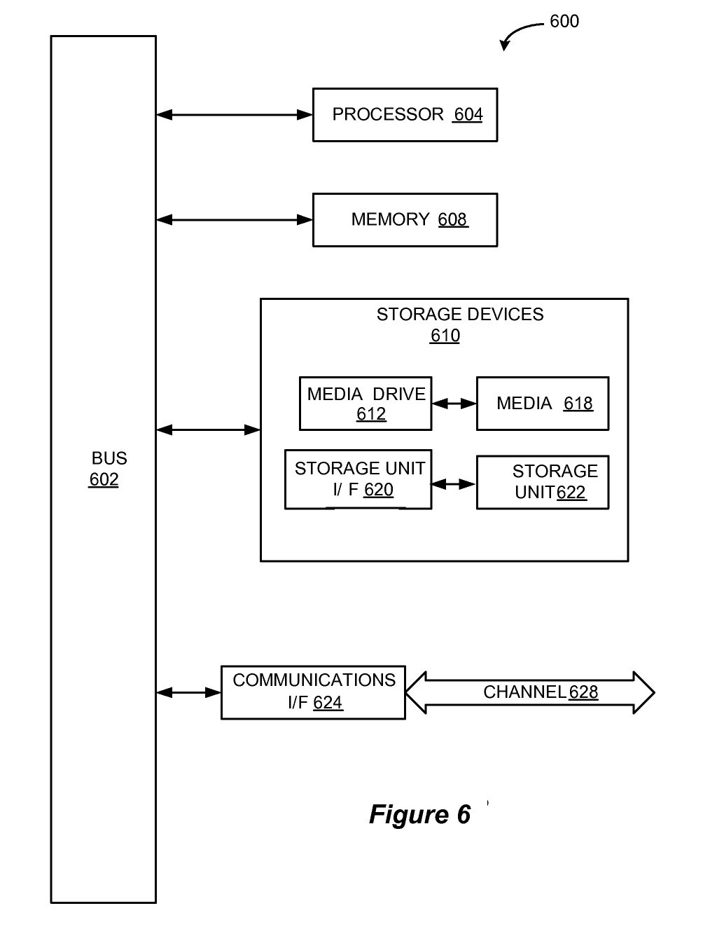

FIG. 6 illustrates an exemplary computing system 600 that may be employed to implement processing functionality for various aspects of the invention (e.g., as a server device, client device, database, presence platform, combinations thereof, and so on). Those skilled in the relevant art will also recognize how to implement the invention using other computer systems or architectures. Computing system 600 may represent, for example, a desktop, mainframe, server, client, or any other type of special or general purpose computing device as may be desirable or appropriate for a given application or environment. Computing system 600 can include one or more processors, such as a processor 604. Processor 604 can be implemented using a general or special purpose processing engine such as, for example, a microprocessor, microcontroller or other control logic. In this example, processor 604 is connected to a bus 602 or other communication medium.

Computing system 600 can also include a main memory 608, for example random access memory (RAM) or other dynamic memory, for storing information and instructions to be executed by processor 604. Main memory 608 also may be used for storing temporary variables or other intermediate information during execution of instructions to be executed by processor 604. Computing system 600 may likewise include a read only memory (“ROM”) or other static storage device coupled to bus 602 for storing static information and instructions for processor 604.

The computing system 600 may also include information storage mechanism 610, which may include, for example, a media drive 612 and a removable storage interface 620. The media drive 612 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 618 may include, for example, a hard disk, floppy disk, magnetic tape, optical disk, CD or DVD, or other fixed or removable medium that is read by and written to by media drive 614. As these examples illustrate, the storage media 618 may include a computer-readable storage medium having stored therein particular computer software or data.

In alternative embodiments, information storage mechanism 610 may include other similar instrumentalities for allowing computer programs or other instructions or data to be loaded into computing system 600. Such instrumentalities may include, for example, a removable storage unit 622 and an interface 620, such as a program cartridge and cartridge interface, a removable memory (for example, a flash memory or other removable memory module) and memory slot, and other removable storage units 622 and interfaces 620 that allow software and data to be transferred from the removable storage unit 618 to computing system 600.

Computing system 600 can also include a communications interface 624. Communications interface 624 can be used to allow software and data to be transferred between computing system 600 and external devices. Examples of communications interface 624 can include a modem, a network interface (such as an Ethernet or other NIC card), a communications port (such as for example, a USB port), a PCMCIA slot and card, etc. Software and data transferred via communications interface 624 are in the form of signals which can be electronic, electromagnetic, optical, or other signals capable of being received by communications interface 624. These signals are provided to communications interface 624 via a channel 628. This channel 628 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 608, storage device 618, storage unit 622, or signal(s) on channel 628. These and other forms of computer-readable media may be involved in providing one or more sequences of one or more instructions to processor 604 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into computing system 600 using, for example, removable storage drive 614, drive 612 or communications interface 624. The control logic (in this example, software instructions or computer program code), when executed by the processor 604, causes the processor 604 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention. Moreover, aspects of the invention describe in connection with an embodiment may stand alone as an invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A method for dynamically generating online contacts for an instant messaging (IM) environment in response to receiving login information from a user, the method comprising:
receiving at least one predetermined core IM contact associated with the user at a core IM server;
receiving a query for a presence status of at least one predetermined e-mail contact associated with the user from an e-mail application;
determining a presence status for the at least one predetermined core IM contact and the at least one predetermined e-mail contact; and
returning the determined presence status of the at least one predetermined core IM contact for consolidating with the determined presence status of the at least one e-mail contact, from which an online presence contact list is generated.

2. The method of claim 1, further comprising determining an IM capability for the at least one predetermined e-mail contact.

3. The method of claim 1, wherein the presence status indicates a status selected from a group consisting of: online, offline, busy, and idle.

4. The method of claim 1 further comprising receiving at least one non-core IM contact; and determining a presence status of the at least one non-core IM contact.

5. The method of claim 1, further comprising determining a privacy setting for the at least one predetermined core IM contact and the at least one predetermined e-mail contact.

6. The method of claim 5, wherein the online presence contact list comprises only the at least one predetermined core IM contact if the presence status indicates an online status and the determined privacy setting allows for inclusion on the online contact list, and the at least one predetermined e-mail contact if the presence status indicates an online status and the determined privacy setting allows for inclusion on the online contact list.

7. The method of claim 1, wherein the e-mail application is an e-mail address book.

8. The method of claim 1, wherein determining a presence status for the at least one predetermined core IM contact and the at least one predetermined e-mail contact comprises requesting the presence status from the core IM server.

9. An apparatus for dynamically generating online contacts for an instant messaging (IM) environment in response to receiving login information from a user, the apparatus comprising:
logic for receiving at least one predetermined core IM contact associated with the user from a user database;
logic for determining a presence status for the at least one predetermined core IM contact and the at least one predetermined e-mail contact, wherein the at least one predetermined e-mail contact is associated with a user and received from an e-mail application; and
logic for sending the determined presence status of the at least one predetermined core IM contact for consolidating with the determined presence status of the at least one e-mail contact, from which an online presence contact list is generated.

10. The apparatus of claim 9, further comprising logic for determining an IM capability for the at least one predetermined e-mail contact.

11. The apparatus of claim 9, wherein the logic for determining the presence status for the at least one predetermined core IM contact and the at least one predetermined e-mail contact includes logic for requesting the presence status from an IM server.

12. The apparatus of claim 9, further comprising a memory for storing the at least one predetermined core IM contact.

13. A computer-readable medium comprising program code for dynamically generating online contacts for an instant messaging (IM) environment in response to receiving login information from a user, the program code for:
receiving at least one predetermined core IM contact associated with the user at a core IM server;
receiving a query for a presence status of at least one predetermined e-mail contact associated with the user from an e-mail application;
determining a presence status for the at least one predetermined core IM contact and the at least one predetermined e-mail contact; and
returning the determined presence status of the at least one predetermined core IM contact for consolidating with the determined presence status of the at least one e-mail contact, from which an online presence contact list is generated.

14. The computer-readable medium of claim 13, further comprising program code for determining an IM capability for the at least one predetermined e-mail contact.

15. The computer-readable medium of claim 13, wherein the presence status indicates a status selected from a group consisting of: online, offline, busy, and idle.

16. The computer-readable medium of claim 1, further comprising program code for receiving at least one non-core IM contact; and determining a presence status of the at least one non-core IM contact.

17. The computer-readable medium of claim 13, further comprising program code for determining a privacy setting for the at least one predetermined IM contact and the at least one predetermined e-mail contact.

18. The computer-readable medium of claim 17, wherein the online presence contact list comprises only the at least one predetermined core IM contact if the presence status indicates an online status and the determined privacy allows for inclusion on the online contact list, and the at least one predetermined e-mail contact if the presence status indicates an online status and the determined privacy allows for inclusion on the online contact list.

19. The computer-readable medium of claim 13, wherein the e-mail application is an e-mail address book.

20. The computer-readable medium of claim 13, wherein determining the presence status for the at least one predetermined core IM contact and the at least one predetermined e-mail contact comprises requesting the presence status from an IM server.
